(19) United States
(12) Patent Application Publication
(10) Pub. No.: US 2026/0327056 A1
(43) Pub. Date: Oct. 22, 2026

(54) CLEANING SYSTEM FOR A FILLING VALVE AND RESPECTIVE METHOD

(71) Applicant: SIDEL PARTICIPATIONS, Octeville-sur-Mer (FR)

(72) Inventors: Stefano ROSINI, Parma (IT); Lionel LICHNEWSKY, Parma (IT); Matteo ORLANDINI, Parma (IT)

(21) Appl. No.: 19/111,205

(22) PCT Filed: Jul. 11, 2023
(86) PCT No.: PCT/EP2023/069108

§ 371 Date: Mar. 12, 2025

(30) Foreign Application Priority Data
Sep. 13, 2022 (IT) 102022000018699

(51) Int. Cl. B67C 3/00; B67C 3/28

(52) U.S. Cl. CPC B67C 3/001; B67C 3/28

(57) ABSTRACT

A cleaning system is described for cleaning a magnetic or electromagnetically actuated filling valve. The valve is configured to dose a pourable product into containers containing ferromagnetic particles in suspension. The cleaning system: includes a cleaning circuit that recirculates a washing fluid through the filling valve, along a flow direction, to define a washing operation and remove ferromagnetic particles accumulated in the filling valve. The system and also includes a magnetic filter arranged along the circuit in a position downstream of the filling valve, with respect to said flow direction, to filter the ferromagnetic particles carried by the washing fluid during the washing operation.

### TECHNICAL FIELD

The present invention relates to a cleaning system for cleaning a magnetic or electromagnetically actuated filling valve configured to dose into containers a pourable product, preferably of the foodstuff type, containing ferromagnetic particles in suspension.

The present invention also relates to a method for automatically cleaning a magnetic or electromagnetically actuated filling valve configured to dose into containers a pourable product, preferably Of the foodstuff type, containing ferromagnetic particles in suspension.

### STATE OF THE ART

Filling machines typically used to fill containers, in particular containers made of plastic or glass, for example, bottles or flasks, or of metal material, for example, cans, with a pourable product, preferably of the foodstuff type such as, for example, water, milk, fruit juices, carbonated or non-carbonated soft drinks, or the like are known.

These machines essentially comprise a carousel rotating around a vertical axis, a tank containing the pourable product, and a plurality of valve filling devices or filling valves, which are carried by the carousel at a radially peripheral portion thereof, are connected to the tank by means of respective ducts and are advanced by the carousel along a substantially circular path.

These machines also comprise an inlet device, typically an inlet star wheel configured to sequentially feed empty containers to the carousel, and an outlet device, typically an outlet star wheel configured to receive containers filled with pourable product from the carousel.

In particular, the carousel receives a succession of empty containers from the inlet star wheel and directs the full containers to the outlet star wheel.

The carousel generally comprises a plurality of support elements each adapted to receive and maintain in an upright position, below each filling valve, a respective container to be filled.

Each filling valve is apt to feed, while it is advanced along the aforesaid circular path by the rotary movement imparted to it by the carousel, a predetermined volume of pourable product to the relative container.

Typically, the filling valves of the known type essentially comprise:
a hollow tubular body fixed to a peripheral portion of the carousel and defining internally a flow channel to feed the pourable product to a respective container to be filled placed underneath the tubular body itself;
a shutter that slidingly engages the tubular body and is movable inside the flow channel so as to selectively allow or prevent the outflow of the pourable product to the respective receptacle; and
an actuator configured to move the shutter inside the flow channel defined by the tubular body.

Generally, the tubular body has a longitudinal axis parallel to the axis of the carousel and terminates at its lower end with an axial discharge opening fluidically communicating, in use, with an end opening defined by an upper edge of the respective container to be filled.

The flow channel extends coaxially to the axis of the tubular body and comprises a segment of constant section, usually cylindrical, and at least one segment of variable section, usually truncated-conical, positioned upstream of the discharge opening and narrowing in the direction of the latter, up to a section of minimum diameter.

The shutter, which typically coaxially engages the flow channel, is axially movable inside the flow channel between:
a closing position, in which the shutter seals shut the segment of variable section of the channel, so as to interrupt the flow of the pourable product through the discharge opening; and
an opening position, in which the shutter delimits, together with the segment of variable section, an annular passage communicating fluidically with the discharge opening, so as to allow the flow of the pourable product to the end opening of the respective container.

Actuators of the pneumatic or hydraulic or oleodynamic type are known. The actuators of this type, however, are poorly suited for aseptic applications, as they require a complicated separation between the “dirty” actuation components (which absolutely must remain outside the flow channel) and the “clean” components (for example, the shutter) inside the flow channel.

To overcome this drawback, actuators of the magnetic or electromagnetic type are widespread: they comprise a driving member outside the flow channel and a driven member integral with the shutter and therefore inside the flow channel.

The driven member is usually defined by permanent magnets incorporated in the shutter. The driving member can be defined by:
permanent magnets; in this case, an axial movement of the driving member will correspond to an axial movement of the driven member, thanks to the magnetic interaction between the two members; or by
an electrically energizable solenoid; in this case, according to the electric current supplied to the solenoid, an axial movement of the driven member, and therefore of the shutter, will be determined in one direction or the other thanks to the electromagnetic interaction between the two members.

In this manner, the movement of the shutter is achieved without compromising the sterility and/or asepticity of the filling.

The problem of accumulation of metal dust (in particular ferromagnetic particles) inside the flow channel at the shutter, or rather at the driven member (which is usually incorporated in the shutter) is known in the field.

This problem mainly occurs during filling with pourable products containing particles of ferromagnetic material, for example, milk or other chocolate drinks (due to the iron contained in the latter).

At present, this problem is solved by stopping the machine to perform manual cleaning of the filling valves to remove the particles/dust.

However, this operation can be very labor-intensive and time-consuming, especially for carousels carrying a large number of filling valves.

In addition, this solution results in periodic (and sometimes quite frequent) machine shutdowns, which compromise the continuity of the filling process, and a loss of useful time.

In addition, the repeated manual cleaning operation of the shutters can undermine the structural integrity of the sealing elements of each shutter.

In addition, this operation requires the repeated disassembly and reassembly of each filling valve, which subsequently requires sterilization before the next filling process, thereby increasing the time required and overall cost.

### OBJECT AND SUMMARY OF THE INVENTION

The purpose of the present invention is therefore to provide a cleaning system and a relative method for cleaning a magnetic or electromagnetically actuated filling valve, which are of high reliability and limited cost, and allow to overcome at least some of the drawbacks specified above.

According to the invention, this purpose is achieved by a cleaning system, and by a relative method, as claimed in the attached independent claims.

### BRIEF DESCRIPTION OF THE DRAWINGS

For a better understanding of the present invention, a preferred non-limiting embodiment thereof is described in the following, purely by way of example and with the aid of the attached drawings, wherein:

FIGS. 1 to 4 schematically illustrate a filling machine comprising a cleaning system produced according to the present invention, during four respective different operating conditions.

### DETAILED DESCRIPTION

With reference to the attached figures, 1 indicates, as a whole, a filling machine configured to fill containers 2 with a pourable product, preferably a foodstuff product, containing ferromagnetic particles in suspension.

For example, the machine 1 fills the containers 2 with chocolate milk which, as is known, contains iron.

The containers 2 can be defined, for example, by bottles or flasks, made of plastic or glass, or by cans made of metallic material (aluminum).

The machine 1 comprises, essentially:
a conveyor to advance the containers 2 to be filled along a filling path, in particular a carousel 3 rotatable around an axis X (preferably vertical) and having a plurality of peripheral receiving seats to carry respective containers 2;
a tank 4 to contain the pourable product;
a plurality of filling valves 5 (only one of which is illustrated in the attached figures) peripherally carried by the carousel 3 so as to overlap the receiving seats, each fluidically connected to the tank by means of a duct 6, and each configured to dose a predetermined amount of pourable product into a respective container 2 arranged below it.

In particular, each filling valve 5 is selectively activatable to control the outflow of the pourable product to a respective container 2 carried by the carousel 3 and placed vertically below the valve 5 itself.

For the sake of simplicity, reference will be made in the following to a single filling valve 5. However, the structural and functional characteristics described for this filling valve 5 are equally applicable to each filling valve 5 carried by the carousel 3.

The filling valve 5 comprises:
a tubular body 7 having a preferably straight longitudinal axis, defining internally a flow channel for the pourable product, and terminating at an end thereof with a discharge opening for feeding the pourable product to a respective container 2;
a shutter 10 engaging the flow channel and axially movable therein between an opening position (known per se and not illustrated in detail), to allow the passage of fluid through the flow channel, and a closing position (known per se and not illustrated in detail), to prevent the passage of fluid through the flow channel, according to a manner known and not described in detail; and
an actuator (known per se and not illustrated) of a magnetic or electromagnetic type configured to control the movement of the shutter 10 inside the flow channel, according to a manner known and not described in detail.

In detail, the actuator comprises a driving member, placed outside the flow channel and radially surrounding the shutter 10, and a driven member placed inside the flow channel and integral with the shutter 10.

In one embodiment, the driving member includes at least one permanent magnet.

In an alternative embodiment, the driving member includes at least one electrically energizable solenoid for generating an electromagnetic field.

The driven member comprises at least one permanent magnet fixed to, preferably incorporated in, the shutter 10. The need to perform a periodic washing operation of the filling valves 5, the tank 4 and the various ducts 6 (and in addition the other piping of the machine 1 used to convey pourable product) is known in the field.

For this purpose, the machine 1 comprises a cleaning circuit 11 configured to recirculate a washing fluid, for example, caustic soda or acids or the like, through the tank 4, the ducts 6 and the filling valves 5, along a flow direction D, to define a washing operation of the machine 1.

In particular, the cleaning circuit 11 comprises a recirculation duct 11a which passes through, precisely, the tank 4, the ducts 6 and the flow channel of each valve 5, so as to lap the shutter 10.

In practice, the filling valve 5 is arranged along the duct 11a, namely, along the circuit 11, and the flow channel defines a portion of the circuit 11, with the shutter 10 defining a valve member within the circuit 11 itself.

Therefore, the shutter 10 in the open position allows the passage of the pourable product to a respective container 2 or the passage of the washing fluid during said washing operation, and the shutter 10 in the closed position prevents the passage of the pourable product to a respective container 2 or the passage of the washing fluid during said washing operation.

Naturally, during the aforesaid washing operation, the pourable product is emptied from the machine 1.

The circuit 11 further comprises:
pumping means, for example, a hydraulic pump 12, for recirculating, namely, for advancing, the washing fluid along the duct 11a;
a discharge duct 13 arranged along the circuit 11 in a position fluidically downstream of the filling valve 5, with respect to the flow direction D;
a feed duct 14 configured to feed a rinse fluid to the circuit 11 itself (namely, to the duct 11a), so that the rinse fluid is conveyed (by means of the duct 11a) through the filling valve 5 to define a rinsing step of the washing operation;
heating means 15 arranged along the duct 11a (namely, along the circuit 11) and configured to heat the washing fluid up to a desired temperature, thereby defining a heating step of said washing operation; and
valve members 16a, 16b, 16c distributed appropriately along the duct 11a.

In detail, the heating means include a heat exchanger 15 arranged along the duct 11a so as to define a heat exchange interface between the washing fluid and a heating fluid, for example industrial waste steam.

A first valve member 16a is fluidically interposed between the feed duct 14 and the duct 11a, to selectively allow or prevent the feeding of the rinse fluid along the duct 11a.

A second valve member 16b is fluidically interposed between the discharge duct 13 and the duct 11a, to selectively allow or prevent the discharge of the washing fluid or the rinse fluid or the pourable product from the circuit 11.

A third valve member 16c is arranged along the duct 11a and fluidically interposed between the discharge channel 13 and the feed channel 14, with respect to the flow direction D.

As it is known, in use, in order to perform the washing operation, firstly any remaining pourable product is evacuated through the discharge duct 13. Then, the discharge opening of each filling valve 5 is closed by means of a so-called “dummy bottle”. Then, the washing fluid is introduced into the duct 11a, heated and recirculated several times for a predetermined treatment time. Next, the rinsing step is performed by feeding rinse fluid through the feed channel 14. Then, the rinse fluid is discharged through the discharge duct 13.

The problem of accumulation of metal dust, in particular the aforesaid ferromagnetic particles, inside the flow channel at the shutter 10, or rather at the driven member, is also known in the field.

According to one aspect of the present invention, the machine 1 comprises an automatic cleaning system 17 for cleaning (automatically) the filling valve 5 in order to remove the ferromagnetic particles.

The cleaning system 17 comprises:
the aforesaid circuit 11, for recirculating the washing fluid through the filling valve 5 to define the washing operation and remove the ferromagnetic particles accumulated at the filling valve 5, namely, within the flow channel and at the shutter 10; and
a magnetic filter 18 arranged along the circuit 11 (in particular along the duct 11a) in a position fluidically downstream of the filling valve 5, with respect to the flow direction D, and configured to be lapped by the washing fluid to automatically filter and collect the ferromagnetic particles within the washing fluid during said washing operation.

In detail, the magnetic filter 18 comprises:
a collection chamber 19 arranged so as to be passed through by the washing fluid circulating along the duct 11a; and
one or more magnetic bars 20, for example each consisting of a permanent magnet, adapted to engage the collection chamber 19 to interact magnetically with the washing fluid.

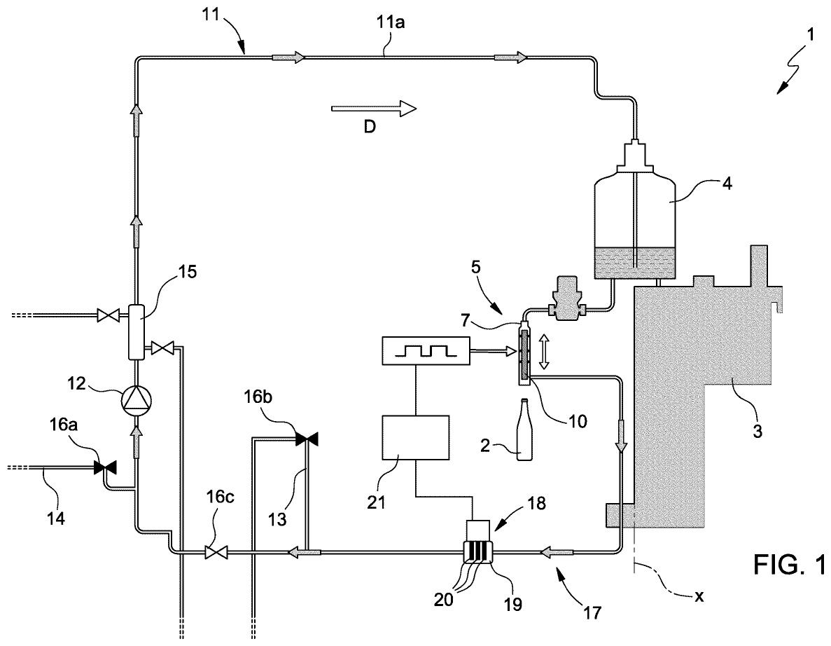

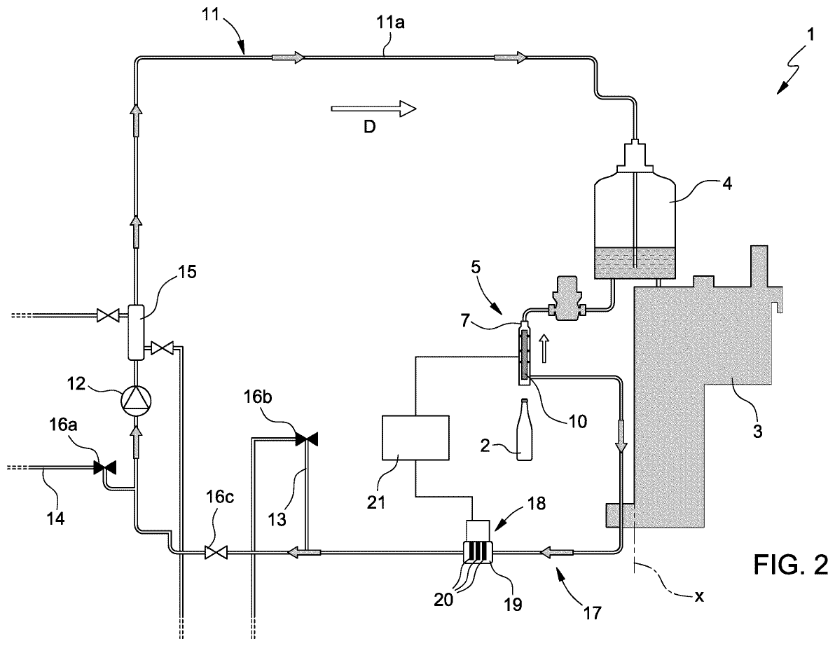

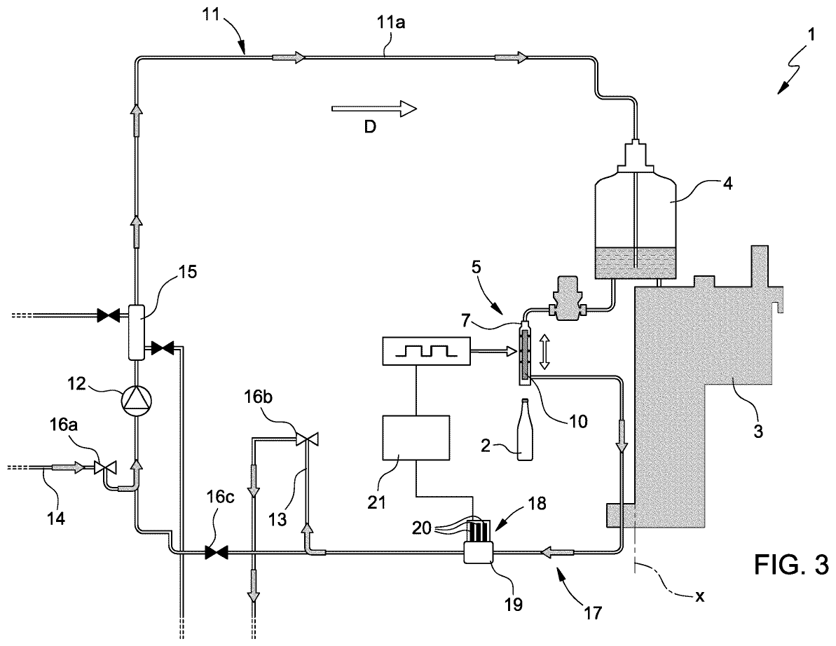

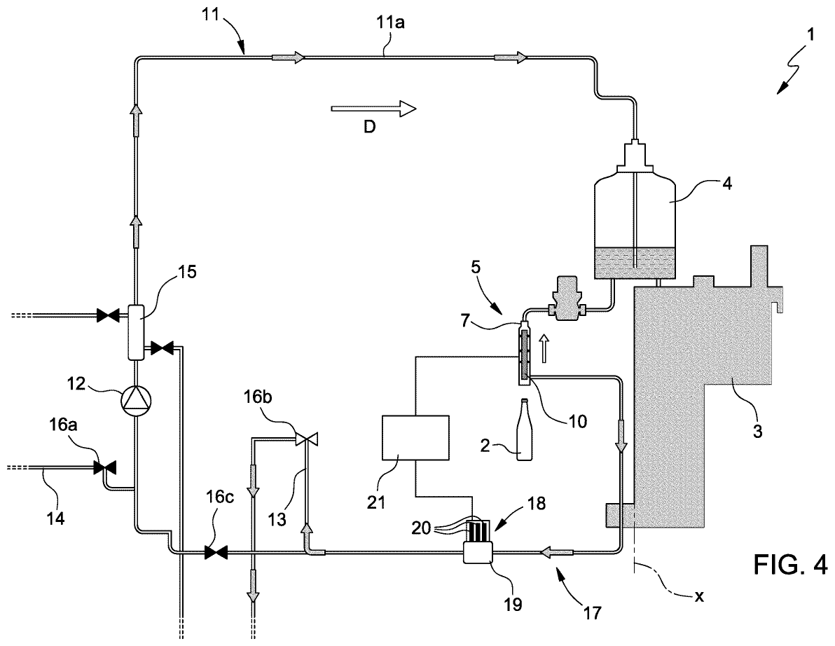

More precisely, the magnetic filter 18 is available in:
a rest configuration (FIGS. 3 and 4), in which its magnetic interaction with the washing fluid is prevented, and in particular in which the magnetic bars 20 are arranged outside of the collection chamber 19; and
a filtering configuration (FIGS. 1 and 2), in which it magnetically interacts with the washing fluid to attract the ferromagnetic particles, and in particular in which the magnetic bars 20 engage the collection chamber 19.

The system 17 also comprises a control unit 21 operatively connected to the magnetic filter 18 to automatically arrange it in the rest configuration and in the filtering configuration.

The control unit 21 is operatively connectable, in particular connected, to the shutter 10.

According to a further aspect of the present invention, the control unit 21 is configured to automatically control a repeated reciprocating motion of the shutter 10 between the opening position and the closing position during the aforesaid washing operation.

In FIGS. 1 and 2, this reciprocating motion is schematically illustrated as a square wave, intended to represent the (upper) opening position and the (lower) closing position assumed repeatedly by the shutter 10.

Thanks to this repeated reciprocating motion of the shutter 10, preferably in combination with the effect of a given flowrate of fluid through the flow channel defined by the pump 12, the detachment and subsequent removal of the ferromagnetic particles from the shutter 10 is facilitated.

Conveniently, the control unit 21 is configured to control the repeated reciprocating motion of the shutter 10 when the magnetic filter 18 is arranged in the filtering configuration, namely, when the magnetic bars 20 engage the collection chamber 19.

In this manner, the ferromagnetic particles removed from the shutter 10 are attracted by the magnetic bars 20, therefore being magnetically filtered and thereby avoiding their continuous recirculation along the circuit 11, namely, the duct 11a, which would lead to their magnetic reattachment to the shutter 10.

As better explained in the following, when the bars 20 are extracted from the chamber 19, namely, when the filter 18 is arranged in the rest configuration, the ferromagnetic particles are collected in the chamber 19 itself, and then expelled through the discharge channel 13 during a discharge step of the washing operation.

Therefore, the magnetic filter 18 is conveniently fluidically interposed between the filling valve 5 and the discharge channel 13, or better yet between the filling valve 5 and the inlet of the discharge channel 13, which is selectively openable by means of the second valve member 16b.

Advantageously, the control unit 21 is configured to control the repeated reciprocating motion of the shutter 10 during the heating step, namely, when the exchanger 15 is activated to heat the washing fluid (FIG. 1).

In this manner, the removal of the ferromagnetic particles from the shutter 10 is further facilitated. The Applicant has in fact observed that the attractive magnetic force of the driven member incorporated in the shutter 10 decreases as the temperature increases. Therefore, this arrangement allows (together with the reciprocating motion of the shutter 10 and preferably with the aforesaid increase in flowrate) to increase the detachment rate of the ferromagnetic particles by exploiting a pre-existing step (i.e., the heating step) of the washing operation.

Conveniently, in the aforesaid heating step, the magnetic filter 18 is arranged in the filtering configuration, so as to filter and collect the ferromagnetic particles within the washing fluid.

The control unit 21 is configured to control the exchanger 15 to maintain the washing fluid at said desired temperature during the recirculation of the washing fluid, thereby defining a treatment step of the washing operation schematically illustrated in FIG. 2.

Advantageously, the control unit 21 is configured to maintain the shutter 10 in the opening position during said treatment step.

In other words, the reciprocating motion of the shutter 10 is interrupted during the temperature treatment step. This makes it easy to control the degree of cleanliness achieved during the washing operation. More precisely, this degree of cleanliness is usually detected/measured by means of data coming from flowmeters. Maintaining the shutter 10 stationary in the opening position therefore has the advantage of not fluidically affecting the measurement of the relative flowmeter. In fact, in this step the objective is to clean the valve, while the removal of the ferromagnetic particles is maximized in the previous heating step.

Preferably, in the aforesaid treatment step, the magnetic filter 18 is therefore arranged in the filtering configuration, so as to filter and collect any ferromagnetic particles that detach from the shutter 10.

The discharge channel 13 is configured to expel the washing fluid or the rinse fluid or the pourable product from the circuit 11, according to the operating step, thereby defining the aforesaid discharge step.

FIG. 4 illustrates the discharge step. In this step, the second valve member 16b is opened to allow fluid to be expelled downstream of the filter 18 and upstream of the feed channel 14 and the hydraulic pump 12.

Appropriately, the third valve member 16c is closed to prevent fluid recirculation in lieu of its expulsion.

Preferably, the control unit 21 is configured to maintain the shutter 10 in the opening position during said discharge step.

Advantageously, the control unit 21 is configured to automatically arrange the magnetic filter 18 in the rest configuration during said discharge step, as schematically illustrated in FIG. 4. In this manner, the magnetic bars 20 are extracted from the chamber 19 and the magnetic particles collected therein are expelled from the circuit 11.

FIG. 3 schematically illustrates the aforesaid rinsing step. During this step, some rinse fluid is introduced into the duct 11a by means of the feed duct 14 (the first valve member 16a is appropriately opened), to pass through the tank 4, the ducts 6 and the valves 5 for the purpose of removing any residual washing fluid (previously discharged through the discharge duct 13 during the discharge step).

It should be noted that during this step, both the first valve member 16a and the second valve member 16b are opened, and the third valve member 16c is closed. In this manner, the rinse fluid is not recirculated but simply expelled after having passed through part of the duct 11a.

As can be seen in this figure, advantageously the control unit 21 is configured to control the repeated reciprocating motion of the shutter 10 even during the rinsing step.

Thanks to this arrangement, the removal of the ferromagnetic particles from the shutter 10 is further facilitated, by exploiting a pre-existing step (the rinsing step) of the washing operation.

Preferably, the control unit 21 is also configured to automatically arrange the magnetic filter 18 in the rest configuration during said rinsing step. In this manner, the magnetic bars 20 are extracted from the chamber 19 and the magnetic particles collected therein are expelled from the circuit 11.

From the above, it is clear how the cleaning system 17 is configured to automatically remove the ferromagnetic particles accumulated in the flow channel, automatically filter the ferromagnetic particles within the washing fluid, and automatically discharge the filtered ferromagnetic particles.

A preferred operating mode of the filling machine 1 and of the automatic cleaning system 17 according to the present invention will be described in the following, with reference to an initial condition in which a filling operation of containers 2 is finished.

In this condition, a first discharge step is performed to discharge the residual pourable product through the circuit 11 and, in particular, through the discharge duct 13. In this step, the control unit 21 controls the magnetic filter 18 in the rest configuration, the second valve member 16b is open and the shutter 10 in the opening position, and the pump 12 is stopped.

Next, a first rinsing step is performed by feeding the rinse fluid (for example, water) through the feed duct 14. In this step, the second valve member 16b is open (to discharge the rinse fluid without recirculation), the magnetic filter 18 is arranged in the rest configuration (so that any ferromagnetic particles detached from the shutter 10 can be directly discharged), the pump 12 is active, and the shutter 10 is moved with the aforesaid reciprocating motion.

Next, a second discharge step is performed under the conditions described above.

Then, the heating step is performed: the washing fluid is fed to the duct 11a and is recirculated therein while being heated by means of the exchanger 15. In this step, the magnetic filter 18 is arranged in the filtering configuration and the shutter 10 is moved with reciprocating motion. Naturally, the pump 12 is active to increase the flowrate through the flow channel of the valve 5.

When the desired temperature is reached, the treatment step is performed. The shutter 10 is arranged in the opening position and the magnetic filter 18 remains in the filtering configuration.

Then, a discharge step is again performed, under the conditions described above, then a rinsing step (under the conditions set forth above and in which the ferromagnetic particles collected in the chamber 19 are expelled through the discharge duct 13, as the magnetic filter 18 is arranged in the rest configuration) and then a final discharge step under the conditions described above.

From the foregoing, it is clear how the cleaning system 17 allows to implement a method for automatically cleaning a magnetic or electromagnetically actuated filling valve configured to dose a pourable product containing ferromagnetic particles in suspension into containers, the method comprising the steps of:
a) recirculating a washing fluid through the filling valve, along a flow direction to define a washing operation;
b) removing the ferromagnetic particles accumulated at the filling valve by means of step a) of recirculating;
c) automatically arranging a magnetic filter, fluidically positioned downstream of the filling valve with respect to said flow direction, from a rest configuration, in which its magnetic interaction with the washing fluid is prevented, to a filtering configuration, in which it magnetically interacts with the washing fluid to attract the ferromagnetic particles; and
d) automatically filtering and collecting the ferromagnetic particles within the washing fluid by means of an arrangement of the magnetic filter in the filtering configuration.

Advantageously:
the method also comprises the step of
e) alternately and repeatedly automatically moving said shutter between the opening position and the closing position;
step b) of removing is performed at least by step e) of moving;
step d) of filtering and collecting is performed at least during step e) of moving.

Advantageously:
the method also comprises the step of
f) heating the washing fluid up to a desired temperature;
step e) of moving is performed at least during step f) of heating; and/or
step c) of arranging is performed at least during step f) of heating.

Advantageously, the method also comprises:
g) maintaining the washing fluid at said desired temperature;
maintaining the shutter in the opening position during step g) of maintaining said desired temperature; and/or
performing step c) of arranging at least during step g) of maintaining said desired temperature.

Advantageously, the method also comprises:
i) conveying a rinse fluid through the filling valve to define a rinsing step of the washing operation;
performing step e) of moving during step i) of conveying; and/or
automatically arranging the magnetic filter in the rest configuration during step i) of conveying.

Advantageously, the method also comprises:
1) discharging the washing fluid thereby defining a discharge step of the washing operation;
automatically arranging the magnetic filter in the rest configuration during step 1) of discharging; and/or
maintaining the shutter in the opening position during step 1) of discharging.

The cleaning system 17 comprises the cleaning circuit 11. The cleaning circuit 11 is configured to recirculate a washing fluid through the filling valve 5, along the flow direction D, to define the washing operation and remove ferromagnetic particles accumulated in the filling valve 5.

The system 17 comprises the magnetic filter 18. The magnetic filter 18 is arranged along the circuit 11 in a position downstream of the filling valve 5, with respect to said flow direction D, to filter and/or collect the ferromagnetic particles carried by the washing fluid during said washing operation.

The magnetic filter 18 can assume a rest condition, in which its magnetic interaction with the washing fluid is prevented, and a filtering condition, in which it magnetically interacts with the washing fluid to filter the ferromagnetic particles carried by the recirculating washing fluid. In the rest condition, the magnetic filter 18 does not filter the ferromagnetic particles carried by the recirculating washing fluid.

The valve 5 comprises a shutter 10 that is movable, by means of said magnetic or electromagnetic actuation. The shutter 10 can assume a condition of greater opening of the valve 5 corresponding to a position of greater opening of the shutter 10, a condition of lesser opening of the valve 5 corresponding to a position of lesser opening of the shutter 10, and a condition of reciprocating motion in which it moves alternately between said position of lesser opening and said position of greater opening. The position of lesser opening could be a closing condition. The condition of greater opening could be a condition of maximum opening.

The system 17 comprises pumping means 12. The pumping means 12 can assume a pumping condition in which they pump the washing fluid along the circuit 11, and an inoperative condition in which they do not pump the washing fluid along the circuit 11.

The system 17 comprises heating means 15. The heating means are arranged along the circuit 11 and can assume a temperature increase condition in which they increase the temperature of the recirculating washing fluid, and a maintenance condition in which they maintain the temperature of the recirculating washing fluid.

The system 17 comprises discharge means 13 which can assume a discharge condition in which they cause the washing fluid to be discharged from the circuit 11, and an inactive condition in which they do not cause the washing fluid to be discharged from the circuit 11.

The control unit 21 is configured to automatically and simultaneously control the filter 18 in the filtering condition, the shutter 10 in the condition of reciprocating motion, the pumping means 12 in the pumping condition, the heating means in the temperature increase condition, and the discharge means 13 in the inactive condition.

In this manner, the reciprocating motion of the shutter allows to effectively remove the ferromagnetic particles that have previously accumulated on the shutter 10, and the magnetic filter can effectively block these removed ferromagnetic particles. In addition, the pressure increase effect that is achieved by means of the pumping action can decrease the magnetic or electromagnetic force of the shutter, by means of a mechanical effect of this pressure increase which causes a vertical misalignment between shutter and driving member. In addition, the temperature increase condition allows the effect of removing these particles to be improved, since the magnetic force of the shutter decreases as the temperature increases. The combination of pressure increase and temperature increase allows to achieve an excellent result in terms of the effectiveness of removing the ferromagnetic particles from the shutter 10.

The control unit 21 is configured to automatically and simultaneously control the filter 18 in the rest condition, the shutter 10 selectively in the condition of reciprocating motion or in the condition of greater opening, the pumping means 12 selectively in the pumping condition or in the inoperative condition, and the discharge means 13 in the discharge condition.

In this manner, the washing fluid can be discharged together with the ferromagnetic particles previously filtered by means of the magnetic filter 18.

The previously filtered ferromagnetic particles could also be discharged by circulating along the circuit 11 and discharging another washing fluid, again while maintaining the magnetic filter 18 in the rest condition. Therefore, the ferromagnetic particles can be discharged by means of said washing fluid or said other washing fluid.

The heating means can assume a maintenance condition in which they operate to maintain a constant temperature of the recirculating washing fluid.

The control unit 21 is configured to automatically and simultaneously control the filter 18 in the filtering condition, the shutter 10 selectively in the condition of reciprocating motion or in the condition of greater opening, the pumping means 12 in the pumping condition, the discharge means 13 in the inactive condition, and the heating means in the maintenance condition.

In this manner, the effect of removing and filtering the particles can be optimized even during the treatment step in which the heating means try to maintain a constant temperature.

From an examination of the characteristics of the cleaning system 17 and the relative method obtained according to the present invention, the advantages that they allow to obtain are clear.

In particular, the cleaning system 17 according to the present invention allows to remove the ferromagnetic particles that accumulate within a magnetic or electromagnetically actuated filling valve in an automatic, simple and effective manner, by using the pre-existing washing circuit 11 and washing operation, and without the need for manual intervention by an operator. At the same time, the recirculation of the removed particles is avoided, thanks to the presence of the magnetic filter 18 arranged downstream of the valves 5, which filters and collects the particles that are subsequently expelled by means of the discharge step.

The peculiar repeated reciprocating motion of the shutter 10 according to the invention allows to greatly increase the number of ferromagnetic particles detached and therefore filtered and removed.

The fact that this reciprocating motion is performed during the heating step facilitates the removal of the ferromagnetic particles from the shutter 10, as the attractive magnetic force of the driven member incorporated in the shutter 10 decreases as the temperature increases.

In addition, it is not necessary to dissemble any valve 5 in order to proceed with the manual removal of the particles, which results in significant time and cost savings.

In addition, the structural integrity of the valves 5 is preserved and the service life thereof is increased.

In addition, laborious post-reassembly sterilization prior to the subsequent filling process is avoided, as no valve is disassembled.

In short, the cleaning system 17 allows to increase the performance of the filling process, as the undesired obstructions of the flow channel of each valve 5 is avoided, and as the maintenance and shutdown times of the machine 1 are drastically decreased, therefore causing an increase in the overall efficiency of the filling process.

It is clear that modifications and variations can be made to the cleaning system 17 and to the relative method described and illustrated herein without departing from the scope defined by the claims.

1. A cleaning system for cleaning a magnetic or electromagnetically actuated filling valve, the filling valve configured to dose into containers a pourable product containing ferromagnetic particles in suspension, the cleaning system comprising:
a cleaning circuit configured to recirculate a washing fluid through the filling valve, along a flow direction, wherein the cleaning circuit defines a washing operation and removes the ferromagnetic particles accumulated in the filling valve; and
a magnetic filter arranged along the circuit in a position downstream of the filling valve, with respect to said flow direction, to filter the ferromagnetic particles carried by the washing fluid during said washing operation.

2. The cleaning system as claimed in claim 1, wherein the magnetic filter has a condition selected from a rest condition and a filtering condition;
wherein in the rest condition the magnetic filter is prevented from magnetic interaction with the washing fluid, and
wherein in the filtering condition, the magnetic filter magnetically interacts with the washing fluid to filter the ferromagnetic particles carried by the recirculating washing fluid;
and wherein the system also comprises a control unit configured to automatically control the condition of the magnetic filter, wherein the control unit is operably connectable to a shutter of the filling valve, the filling valve being movable by said magnetic or electromagnetic actuation, wherein the shutter is configured to assume a condition selected from a: condition of greater opening of the valve corresponding to a position of greater opening of the shutter, a condition of lesser opening of the valve corresponding to a position of lesser opening of the shutter, and a condition of reciprocating motion in which the shutter moves between said position of lesser opening and said position of greater opening,
the control unit being configured to automatically control the condition of the shutter,
wherein the control unit is configured to automatically and simultaneously control the filter in the filtering condition and the shutter in the condition of reciprocating motion, so that the ferromagnetic particles accumulated on the shutter are removed by recirculating the washing fluid and filtered by the magnetic filter.

3. The cleaning system according to claim 2, comprising a pumping means that can assume a condition selected from either a pumping condition in which the pumping means pumps the washing fluid along the circuit or an inoperative condition in which the pumping means does not pump the fluid washing along the circuit, wherein the control unit is configured to automatically control the condition of the pumping means;
wherein the control unit is configured to automatically and simultaneously control the filter in the filtering condition, the shutter in the condition of reciprocating motion, and the pumping means pumping condition.

4. The cleaning system according to claim 3, comprising heating means arranged along the circuit, wherein the heating means is configured to assume a temperature increase condition in which the temperature of the recirculating washing fluid increases,
wherein the control unit is configured to automatically control a condition of the heating means;
wherein the control unit is configured to automatically and simultaneously control the filter in the filtering condition, the shutter in the condition of reciprocating motion, the pumping means in the pumping condition, and the heating means in the temperature increase condition.

5. The cleaning system according to claim 4, comprising discharge means having a condition selected from a discharge condition in which the discharge means causes the washing fluid to be discharged from the circuit, and an inactive condition in which the discharge means does not cause the washing fluid to be discharged from the circuit,
wherein the control unit is configured to automatically control the condition of the discharge means;
wherein the control unit is configured to automatically and simultaneously control the filter in the rest condition, the shutter selectively in the condition of reciprocating motion or in the greater opening condition, the pumping means selectively in the pumping condition or in the inoperative condition, and the discharge means in the discharge condition.

6. The cleaning system according to claim 5, wherein the control unit is configured to automatically and simultaneously control the filter in the filtering condition, the shutter in the condition of reciprocating motion, the pumping means in the pumping condition, and the discharge means in the inactive condition.

7. The cleaning system according to claim 5, wherein the control unit is configured to automatically and simultaneously control the filter in the filtering condition, the shutter in the condition of reciprocating motion, the pumping means in the pumping condition, the heating means in the temperature increase condition, and the discharge means in the inactive condition.

8. The cleaning system according to claim 7, wherein the heating means can comprise a maintenance condition in which the heating means maintains the temperature of the recirculating washing fluid;
wherein the control unit is configured to automatically and simultaneously control the filter in the filtering condition, the shutter selectively in the condition of reciprocating motion or in the greater opening condition, the pumping means in the pumping condition, the heating means in the maintenance condition, and the discharge means in the inactive condition.

9. A filling machine for filling containers with a pourable product containing ferromagnetic particles in suspension, the machine comprising:
a conveyor configure to advance the containers to be filled along a filling path;
at least one filling valve configured to dose the pourable product inside at least one container at a time,
the filling valve comprising:
a hollow tubular body internally defining a flow channel;
a shutter engaging the flow channel and movable by magnetic or electromagnetic actuation, the shutter comprising a condition selected from: a condition of greater opening of the valve corresponding to a position of greater opening of the shutter, a condition of lesser opening of the valve corresponding to a position of lesser opening of the shutter, and a condition of reciprocating motion in which the shutter moves between said position of lesser opening and position of greater opening; and
a cleaning system comprising:
a cleaning circuit configured to recirculate a washing fluid through the filling valve, along a flow direction, wherein the cleaning circuit defines a washing operation and removes the ferromagnetic particles accumulated in the filling valve; and
a magnetic filter arranged along the circuit in a position downstream of the filling valve, with respect to said flow direction, to filter the ferromagnetic particles carried by the washing fluid during said washing operation,
wherein the circuit of the system passes through the filling valve to convey the washing fluid inside the flow channel during said washing operation in order to lap the shutter.

10. A method for cleaning a magnetic or electromagnetically actuated filling valve which is configured to dose into containers a pourable product containing ferromagnetic particles in suspension, the method comprising:
recirculating a washing fluid through the filling valve along a flow direction, via a cleaning circuit, to define a washing operation and remove ferromagnetic particles accumulated in the filling valve; and
magnetically filtering, in a position downstream of the filling valve with respect to said flow direction, the ferromagnetic particles carried by the washing fluid during said washing operation.

11. The method as claimed in claim 10, wherein the filling valve comprises a shutter engaging the flow channel and movable by means of magnetic or electromagnetic actuation; the shutter comprising a condition selected from a condition of greater opening of the valve corresponding to a position of greater opening of the shutter, and a condition of lesser opening of the valve corresponding to a position of lesser opening of the shutter;
wherein the method simultaneously includes:
recirculating the washing fluid through the filling valve via the circuit along said flow direction to define said washing operation and to remove the ferromagnetic particles accumulated on the shutter;
magnetically filtering the ferromagnetic particles transported by the recirculating washing fluid during said washing operation, in a position downstream of the filling valve with respect to said flow direction;
moving the shutter alternately between said condition of lesser opening and said condition of greater opening.

12. The method according to claim 11, wherein the method comprises simultaneously:
recirculating the washing fluid through the filling valve via the circuit, along said flow direction, to define said washing operation and to remove ferromagnetic particles accumulated on the shutter;
magnetically filtering the ferromagnetic particles carried by the recirculating washing fluid, during said washing operation, in a position downstream of the filling valve, with respect to said flow direction;
moving the shutter alternately between said condition of lesser opening and said condition of greater opening; and
pumping the washing fluid along the circuit.

13. The method according to claim 12, wherein the method comprises simultaneously:
recirculating the washing fluid through the filling valve via the circuit, along said flow direction, to define said washing operation and to remove ferromagnetic particles accumulated on the shutter;
magnetically filtering the ferromagnetic particles transported by the recirculating washing fluid, during said washing operation, in a position downstream of the filling valve, with respect to said flow direction;
moving the shutter alternately between said condition of lesser opening and said condition of greater opening;
pumping the washing fluid along the circuit; and
increasing a temperature of the recirculating washing fluid.

14. The method according to claim 13, wherein the method comprises discharging the filtered magnetic particles by circulating along said circuit, and discharging from said circuit, said washing fluid or another washing fluid.
